(19) United States
(12) Patent Application Publication
(10) Pub. No.: US 2025/0249735 A1
(43) Pub. Date: Aug. 7, 2025

(54) DEFLECTOR DEVICE AND SUNROOF DEVICE

(71) Applicant: AISIN (SUZHOU) TECHNICAL CENTER CO., LTD., Suzhou (CN)

(72) Inventors: Ryuta FUKADA, Suzhou (CN); Jiefeng ZHANG, Suzhou (CN)

(73) Assignee: AISIN (SUZHOU) TECHNICAL CENTER CO., LTD., Suzhou (CN)

(21) Appl. No.: 18/969,556

(22) Filed: Dec. 5, 2024

(30) Foreign Application Priority Data
Feb. 4, 2024 (CN) 202420273415.5

(51) Int. Cl. B60J 7/22; B60J 7/043

(52) U.S. Cl. CPC B60J 7/22; B60J 7/043

(57) ABSTRACT

A deflector device and a sunroof device, and the deflector device includes: an upper body, where the upper body extends in a vehicle width direction; a pair of deflector arms, where the pair of deflector arms respectively extend from two ends of the upper body in the vehicle width direction toward the rear of the vehicle, and the upper body moves up and down as the pair of deflector arms rotate around rear end portions of the pair of deflector arms; a lower body, where the lower body is mounted on a front housing of the sunroof device, and extends in the vehicle width direction; and a mesh component, where the mesh component is integrally formed with the upper body, the mesh component is separately formed from the lower body, and a lower side edge of the mesh component is connected to the lower body by sewing or welding.

### TECHNICAL FIELD

The invention relates to a deflector device and a sunroof device, and in particular, relates to a deflector device for a sunroof device for a vehicle.

### BACKGROUND ART

In the prior art, a deflector device for a sunroof device is known. When the sunroof device is closed, the deflector is in a storage state. When the sunroof device is opened, the deflector is deployed. A mesh component held between an upper body and a lower body of the deflector prevents air vibration caused by wind entering the vehicle interior. The lower body of the deflector device is fixed to the sunroof device by engaging with the front housing of the sunroof device.

Specifically, referring to the deflector device of the prior art of FIG. 4 and FIG. 5, an upper body 120, a mesh component 123, and a lower body 122 are integrally molded from resin. The lower body 122 includes a plurality of hooks 130 arranged in the vehicle width direction, and a plurality of slot components 131 arranged in the vehicle width direction are formed on the front housing 113. The lower body 122 is mounted on the front housing 113 by respectively engaging a plurality of hooks 130 with the slot components 131. The lower body 122 is removed from the front housing 113 by disengaging the multiple slot components 131 from the hooks 130.

However, the existing deflector device has the following problem: Because the upper body, the mesh component and the lower body are integrally molded from resin, a new integrally formed mold needs to be provided in order to adjust the height of the deflector device in the deployed state (that is, adjust the length of the mesh component), resulting in high manufacturing costs.

### SUMMARY OF THE INVENTION

### Problem to be Solved by the Invention

An objective of the invention is to provide a deflector device that can easily adjust the height and has low cost, and a sunroof device equipped with the deflector device.

### Means for Solving the Problem

A deflector device of a technical solution of the invention is used for a sunroof device on a vehicle roof, and includes: an upper body, where the upper body extends in a vehicle width direction; a pair of deflector arms, where the pair of deflector arms respectively extend from two ends of the upper body in the vehicle width direction toward the rear of the vehicle, and the upper body moves up and down as the pair of deflector arms rotate around rear end portions of the pair of deflector arms; a lower body, where the lower body is mounted on a front housing of the sunroof device and extends in the vehicle width direction; and a mesh component, where the mesh component is integrally formed with the upper body, the mesh component is separately formed from the lower body, and a lower side edge of the mesh component is connected to the lower body by sewing or welding.

According to the above technical solution, because the mesh component is integrally formed with the upper body and separately formed from the lower body, the height of the deflector device in the deployed state can be easily adjusted by changing the length of the mesh component, the cost is low. In addition, the lower side edge of the mesh component is connected to the lower body by sewing or welding, so that the integrated upper body and the mesh component can be easily connected to the lower body.

In addition, in the above technical solution, preferably, a plurality of protrusions are provided on the front housing, and a plurality of holes are provided on the lower body, and the lower body is fixed to the front housing by respectively inserting the plurality of protrusions into the plurality of holes.

Thus, the lower body can be easily fixed to the front housing by respectively inserting the plurality of protrusions of the front housing into the plurality of holes of the lower body.

In addition, in the above technical solution, preferably, the lower body is made of PET material, and the upper body and the mesh component are made of resin.

Thus, compared with the integrally formed upper body and mesh component, the material of the lower body is softer, and the lower body can be well sewn or welded with the mesh component, and the lower body can be easily fixed to the front housing.

In addition, in the above technical solution, preferably, the lower body is composed of a plurality of separate members.

In addition, in the above technical solution, preferably, the lower body is an integral structure.

In addition, in the above technical solution, preferably, the lower body is mounted on the front housing by means of snap-fitting.

Thus, the lower body can be easily fixed to the front housing.

Another technical solution of the invention is a sunroof device, and the sunroof device includes: the above deflector device; and a pair of guide rails, where the pair of guide rails extend in a front-rear direction of the vehicle, and are arranged on both side edges of a roof opening in the vehicle width direction, and the rear end portions of the pair of deflector arms are respectively pivotally supported on the pair of guide rails.

According to this technical solution, in the sunroof device, the height of the deflector device can be easily adjusted, and the cost is low.

### BRIEF DESCRIPTION OF THE DRAWINGS

FIG. 1 is a top view schematically showing a deflector device of the invention.

FIG. 2 is a perspective view showing a deployed state of a deflector device of the invention.

FIG. 3 is a side sectional view showing a deployed state of a deflector device of the invention.

FIG. 4 is a perspective view showing a deployed state of a deflector device of the prior art.

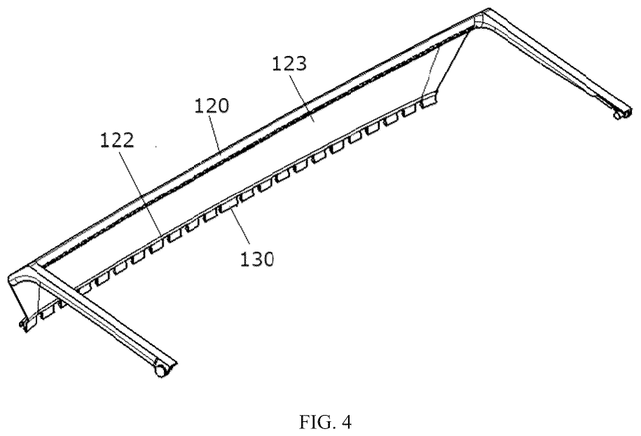

FIG. 5 is a side sectional view showing a deployed state of a deflector device of the prior art.

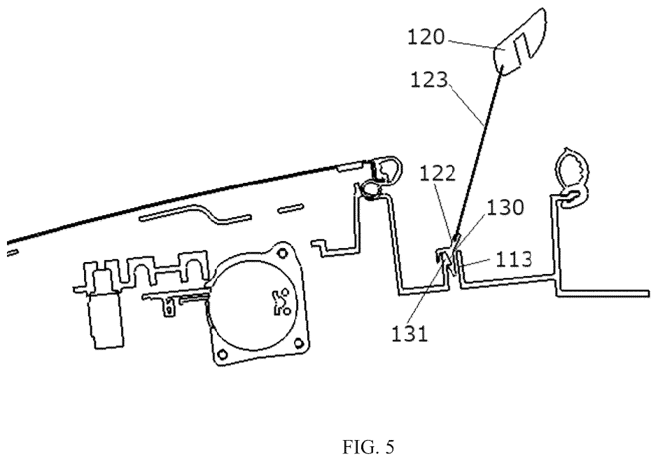

### EMBODIMENTS OF THE INVENTION

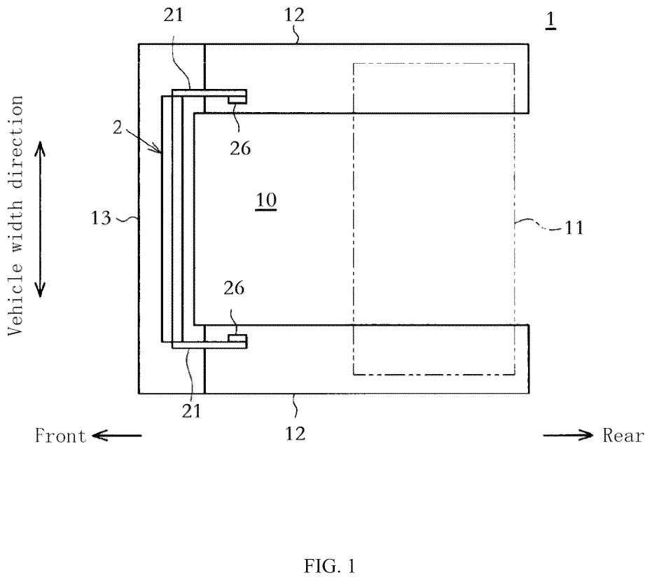

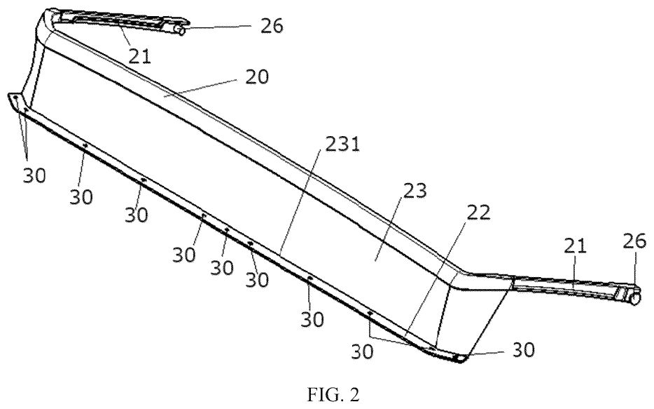

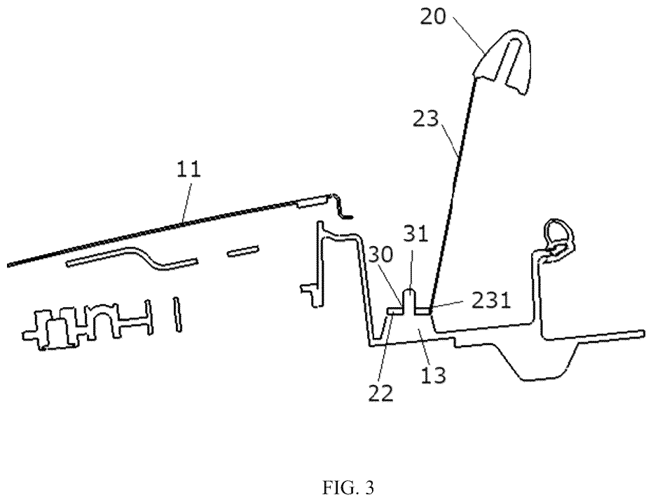

Hereinafter, a deflector device for a sunroof device of the invention is specifically described with reference to FIGS. 1 to 3.

In this embodiment, a sunroof device 1 is installed on the roof of a vehicle. The sunroof device 1 includes: a pair of guide rails 12, where the pair of guide rails 12 extend in a vehicle front-rear direction and are arranged at both side edges of a roof opening 10 in a vehicle width direction so as to be arranged oppositely in the vehicle width direction; a front housing 13 extending in the vehicle width direction and connecting front end portions of the pair of guide rails 12; a movable panel 11; and a deflector device 2.

A guide member (not shown) supporting the movable panel 11 moves along the pair of guide rails 12 toward the rear (hereinafter referred to as “rear”) in the vehicle front-rear direction, so that the movable panel 11 moves toward the rear to expose the roof opening 10, thereby opening the sunroof device 1.

The deflector device 2 includes: an upper body 20; a pair of deflector arms 21; a lower body 22; and a mesh component 23.

The upper body 20 extends in the vehicle width direction, and the pair of deflector arms 21 respectively extend from two ends of the upper body 20 in the vehicle width direction toward the rear of the vehicle, and the upper body 20 moves up and down as the pair of deflector arms 21 rotate around rear end portions of the pair of deflector arms 21. More specifically, the rear ends of the pair of deflector arms 21 are pivotally supported on the front end portions of the pair of guide rails 12 through a shaft 26 extending in the vehicle width direction. Thus, the rear end portions of the pair of deflector arms 21 are respectively pivotally supported on the pair of guide rails 12.

The upper body 20 moves up and down as the pair of deflector arms 21 rotate. When the sunroof device 1 is closed, the upper body 20 is in a storage position and is retracted under the movable panel 11. When the movable panel 11 moves backward to open the sunroof device 1, the deflector arm 21 rotates by the force of the elastic force applying member not shown in the figure, and drives the upper body 20 to move to the deployment position.

The lower body 22 is mounted on the front housing 13 of the sunroof device 1 and extends in the vehicle width direction. More specifically, the lower body 22 is mounted and fixed to the front housing 13.

In this embodiment, the mesh component 23 is integrally formed with the upper body 20, and the mesh component 23 is separately formed from the lower body 22. More specifically, in this embodiment, the mesh component 23 and the upper body 20 are integrally formed from resin, and the lower body 22 is made of PET material (thermoplastic polyester). The integral forming body of the mesh component 23 and the upper body 20 are connected to the lower body 22 by sewing or welding the lower body 22 to the lower side edge 231 of the mesh component 23.

Because the upper body 20 and the mesh component 23 are made of resin and the lower body 22 is made of PET material, the lower body 22 is softer than the integral forming body of the upper body 20 and mesh component 23, and the lower body 22 made of PET material can be easily sewn or welded to the lower side edge 231 of the mesh component 23.

The lower body 22 is an integral structure. More specifically, the lower body 22 is in the shape of a plate extending in the vehicle width direction. A plurality of holes 30 are provided in the lower body 22. That is, a plurality of holes 30 arranged in the vehicle width direction are formed in the plate-shaped lower body 22 from top to bottom. The number and arrangement of the holes 30 can be set according to actual needs and are not limited.

Corresponding to the holes 30, a plurality of protrusions 31 are provided on the front housing 13. For example, the plurality of protrusions 31 are arranged in the vehicle width direction. The lower body 22 is fixed to the front housing 13 by respectively inserting the plurality of protrusions 31 into the plurality of holes 30. In addition, the holes 30 are formed in the lower body 22 made of PET material, and therefore the fixation between the holes 30 and the protrusions 31 of the front housing 13 is more reliable.

The operation of the deflector device 2 is described below.

As the upper body 20 moves from the storage position to the deployment position, the mesh component 23 is deployed in a planar manner between the upper body 20 and the lower body 22. The mesh component 23 has a width dimension roughly corresponding to the roof opening 10, so that when the sunroof device 1 is opened, the air blown into the vehicle interior from the front of the vehicle through the roof opening 10 is rectified to prevent air vibration caused by wind being drawn into the vehicle interior.

When the sunroof device 1 is closed, the movable panel 11 moves forward, and pushes the deflector arm 21 to rotate downward, the upper body 20 moves downward accordingly and drives the mesh component 23 to be retracted.

According to the deflector device 2 of this embodiment, the following technical effects can be achieved.

(1) Because the mesh component 23 and the upper body 20 are integrally formed, the length of the mesh component 23 can be easily adjusted without considering the lower body 22. Thus, the height of the deflector device 2 is easily adjusted. Moreover, there is no need to open a new mold for the integrally formed three-part structure corresponding to each length of the mesh component 23, but only one mold is needed, and the height of the deflector device can be easily adjusted by designing the mold to adjust the length of the mesh component 23, or by further cutting the formed mesh component 23 to adjust the length of the mesh component 23.

(2) Because the lower body 22 is made of PET material, the lower body 22 can be easily sewn or welded to the mesh member 23.

(3) The plurality of protrusions 31 provided on the front housing 13 are inserted into the holes 30 provided in the lower body 22 made of PET material or are pulled out from the holes 30, so that the lower body 22 can be easily installed on and removed from the front housing 13. And because the lower body 22 is made of PET material, the engagement between the holes 30 of the lower body 22 and the protrusions 31 of the front housing 13 is relatively firm.

The above describes the preferred embodiment of the invention, but the invention is not limited thereto, and various modifications are possible within the scope of the purpose of the invention.

In the above embodiment, the lower body 22 is exemplified as an integral structure, but the invention is not limited thereto, and the lower body 22 can also be composed of a plurality of separate members, and the same effect as the above embodiment can be achieved by providing a hole 30 in each separate member.

In the above embodiment, the plug-in fixing structure of the hole 30 of the lower body 22 and the protrusion 31 of the front housing 13 is exemplified, but the installation method of the lower body 22 and the front housing 13 is not limited to this, and the lower body 22 can also be installed on the front housing 13 by means of snap-fitting.

For the above content, the invention is described with reference to a specific example. However, the invention is not limited to this specific example. A design obtained by a person skilled in the art by applying appropriate design changes to the specific example is also included in the scope of the invention as long as the design has the features of the invention.

### REFERENCE SIGNS LIST

1 Sunroof device
10 Roof opening
11 Movable panel
12 Guide rail
13 Front housing
2 Deflector device
20 Upper body
21 Deflector arm
22 Lower body
23 Mesh component
231 Lower side edge
30 Hole
31 Protrusion
26 Shaft portion

1. A deflector device for a sunroof device on a vehicle roof, comprising:
an upper body, wherein the upper body extends in a vehicle width direction;
a pair of deflector arms, wherein the pair of deflector arms respectively extend from two ends of the upper body in the vehicle width direction toward the rear of the vehicle, and the upper body moves up and down as the pair of deflector arms rotate around rear end portions of the pair of deflector arms;
a lower body, wherein the lower body is mounted on a front housing of the sunroof device and extends in the vehicle width direction; and
a mesh component, where the mesh component is integrally formed with the upper body, the mesh component is separately formed from the lower body, and a lower side edge of the mesh component is connected to the lower body by sewing or welding.

2. The deflector device according to claim 1, wherein
a plurality of protrusions are provided on the front housing, a plurality of holes are provided on the lower body, and the lower body is fixed to the front housing by respectively inserting the plurality of protrusions into the plurality of holes.

3. The deflector device according to claim 1, wherein
the lower body is made of PET material, and the upper body and the mesh component are made of resin.

4. The deflector device according to claim 1, wherein
the lower body is composed of a plurality of separate members.

5. The deflector device according to claim 1, wherein
the lower body is an integral structure.

6. The deflector device according to claim 1, wherein
the lower body is mounted on the front housing by means of snap-fitting.

7. A sunroof device, comprising:
the deflector device according to claim 1; and
a pair of guide rails, wherein the pair of guide rails extend in a front-rear direction of the vehicle, and are arranged on both side edges of a roof opening in the vehicle width direction, and
the rear end portions of the pair of deflector arms are respectively pivotally supported on the pair of guide rails.
